(19) United States
(12) Patent Application Publication
(10) Pub. No.: US 2014/0245081 A1
(43) Pub. Date: Aug. 28, 2014

(54) INFORMATION PROCESSING APPARATUS, PROCESSOR AND CONTROL METHOD OF INFORMATION PROCESSING APPARATUS

(71) Applicant: FUJITSU LIMITED, Kawasaki-shi (JP)

(72) Inventor: YOSUKE NAKAMURA, Kawasaki (JP)

(73) Assignee: FUJITSU LIMITED, Kawasaki-shi (JP)

(21) Appl. No.: 14/272,563

(22) Filed: May 8, 2014

Related U.S. Application Data
(63) Continuation of application No. PCT/JP2011/080255, filed on Dec. 27, 2011.

(51) Int. Cl. G06F 11/07

(52) U.S. Cl. CPC G06F 11/0724
USPC 714/48

(57) ABSTRACT

In an information processing apparatus including a plurality of CPUs communicating data, a CPU generates processed data smaller in size than received data transmitted by another CPU, selects either the received data or the processed data on the basis of control information contained in the received data, and writes the selected data into a log storage unit, thereby reducing the amount of log information to be recorded.

### CROSS-REFERENCE TO RELATED APPLICATION

This application is a continuation application of International Application PCT/JP2011/080255 filed on Dec. 27, 2011, and designated the U.S., the entire contents of which are incorporated herein by reference.

### FIELD

The present invention relates to an information processing apparatus, a processor and a control method of the information processing apparatus.

### BACKGROUND

An information processing apparatus requiring reliability is made highly fault tolerant while needing to analyze a failure if it occurs. For example, in failure analysis of a multiprocessor system that is an information processing apparatus in which processors as a plurality of processors are mounted to be communicable on one system board, a log indicating communication contents between the processors and the like are used. In the multiprocessor system, the communication between the processors is performed in packet units, and the states of the processors transit according to the contents of a transmitted/received packet to proceed the processing in the whole system. The packet has, for example, a header part indicating the kind or the like of the processing and a data part accompanying it.

The log relating to the communication between the processors performed using the packet is sequentially overwritten, for example, in a storage circuit such as a RAM (Random Access Memory) inside the processor. Upon occurrence of a failure in the system, logs for a fixed period before the point in time have been recorded in the storage circuit, so that a failure cause is analyzed by referring to the recorded logs. In the failure analysis based on the recorded logs, in order to limit a suspected location, existence of a packet where an error has occurred is traced first, and then how the error has occurred is analyzed.

The log relating to the communication between the processors is advantageous in terms of failure analysis because the log is recorded in a storage area of the processor and, as the storage area is larger, the amount of recordable logs is larger so that the state transition of hardware can be traced for a longer period. However, generally, most of the storage area of the processor apparatus is used for improving performance of the processor apparatus, and a storage capacity to be given for recording the communication logs is small. Here, if there is a packet not recorded in the communication logs, the failure location is not be narrowed down to make the failure analysis difficult. Further, analysis about the packet of how the error has occurred enables, for example, narrowing down of the concrete failure location, thereby facilitating specification of the concrete failure contents. Thus, the recording device of communication logs is required to record many logs on the assumption that the failure can be reliably detected and the failure location can be specified.

As recording techniques of the log relating to the communication between the processors, there is, for example, a technique of recording all of effective packets transmitted/received via a bus to be monitored as they are (logging technique A). Further, when a cache memory becomes an abnormal state, the abnormal state is detected as abnormality of a transfer packet only after a lapse of a long time thereafter. Hence, to record logs in a long period, a technique of recording only header parts of the effective packets transmitted/received via a bus to be monitored is sometimes used (logging technique B).

Further, a failure monitoring system having an information collecting apparatus that collects log information held in each of calculators to be monitored, and edits changes in configuration or state of the calculators to be monitored as time-series data and edits the same event content data by replacing it with summary data is disclosed in the following Patent Literature 1.
Patent Literature 1: Japanese Laid-open Patent Publication No. 2007-293393

Here, about recording the log of the packet communication between processors, the following points are required. It is possible to perform log collection and recording for a long period and reliable detection of communication abnormality by satisfying all of the following points (1) to (3):

(1) that a packet is transferred accurately and reliably in a correct sequence, which is recorded;
(2) that the data part of the packet is correctly transferred, which is recorded; and
(3) that logs in a longer time can be recorded in a smaller storage area.

The above-described logging technique A writes all of the effective packets as they are in the storage area, and thereby satisfies the above points (1) and (2) and can thus reliably detect communication abnormality. However, since all of the packets are written as logs, the storage area is soon filled, so that information about an older packet is sequentially erased. In other words, the period in which information about a packet is left in the logs is short. Increase in storage area is also conceivable but has problems of constraint in mounting area, increase in power consumption and so on.

Further, the above-described logging technique B writes only the header parts of the effective packets in the storage area and thus satisfies the above points (1) and (3), so that logs in a long period can be recorded. However, since the data parts of the packets are not recorded, the data parts are not analyzed. In other words, the logs themselves can be recorded for many packets but are insufficient information in terms of analysis, so that there is a possibility that communication abnormality occurred in the data part of the packet is not be detected.

### SUMMARY

In an aspect of an information processing apparatus, any one of a plurality of processors communicating data via a bus includes: a receiving unit that receives data transmitted by another processor; a generating unit that generates, on the basis of received data received by the receiving unit, processed data smaller in size than the received data; a selection unit that selects either the received data or the processed data on the basis of control information contained in the received data; and a control unit that writes selected data selected by the selection unit into a storage unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of an information processing apparatus in an embodiment of the present invention;

FIG. 2 is a chart illustrating an example of a packet format;

FIG. 3 is a diagram illustrating a configuration example of a CPU in a first embodiment;

FIG. 4 is a diagram illustrating a configuration example of a log recording unit in the first embodiment;

FIG. 5 is a diagram illustrating a configuration example of a selection circuit in the first embodiment;

FIG. 6 is a diagram for explaining information to be recorded as logs in each CPU;

FIG. 7A is a chart illustrating an example of a recording state of logs before packet transfer;

FIG. 7B is a chart illustrating an example of a recording state of logs after packet transfer;

FIG. 7C is a chart illustrating a comparative reference example of a recording state of logs after packet transfer;

FIG. 8 is a diagram illustrating a configuration example of a selection circuit in a second embodiment; and

FIG. 9 is a chart illustrating an example of a recording state of logs after packet transfer in the second embodiment.

### DESCRIPTION OF EMBODIMENTS

Hereinafter, embodiments of the present invention will be described on the basis of the drawings.

### First Embodiment

A first embodiment of the present invention will be described.

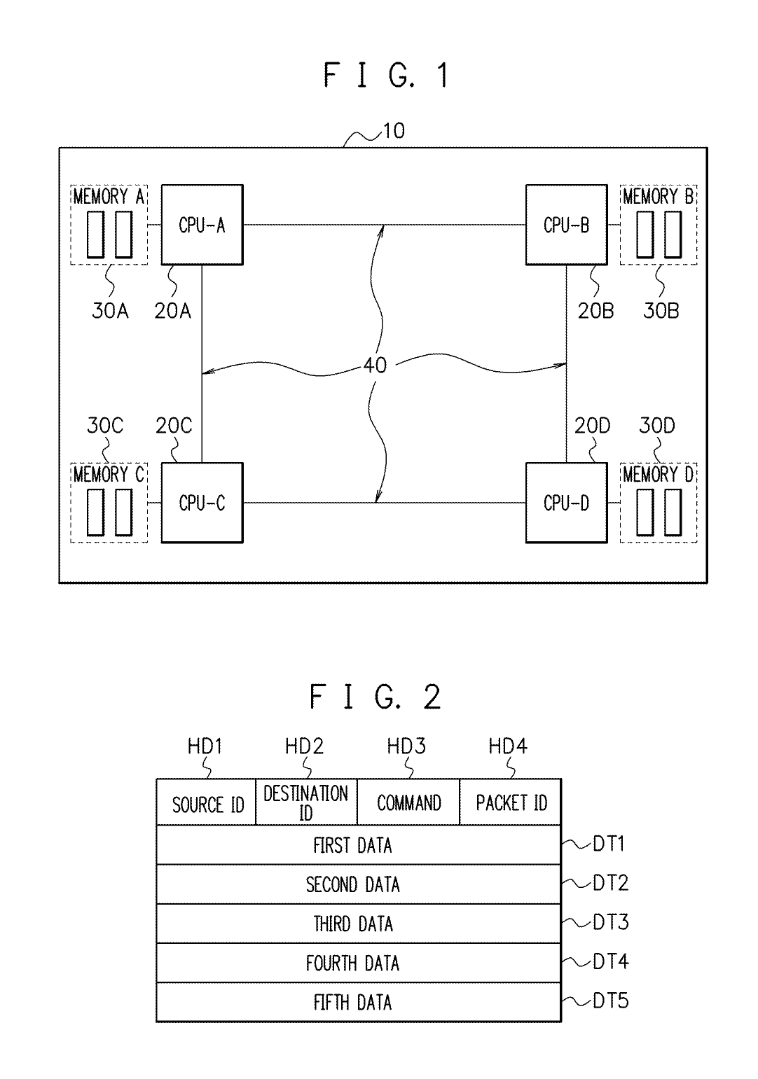

FIG. 1 is a block diagram illustrating a configuration example of a multiprocessor system as an information processing apparatus in the first embodiment. A multiprocessor system 10 has a plurality of processors (for example, CPUs: Central Processing Units) that execute processing according to a program and the like, and the processors are mounted on one system board.

In FIG. 1, a multiprocessor system having, as the processors (processors), four CPUs (CPU chips) such as a CPU (Central Processing Unit) A 20A, a CPU-B 20B, a CPU-C 20C, and a CPU-D 20D is illustrated as an example. The CPUs 20A to 20D are connected to be communicable via a bus 40. Note that in the multiprocessor system in this embodiment, the number of processors to be mounted on one system board is not limited to four but arbitrary. Further, the connection configuration (topology) of the CPUs 20A to 20D is not limited to the connection configuration illustrated in FIG. 1.

A memory A 30A is connected to the CPU-A 20A, and a memory B 30B is connected to the CPU-B 20B. Further, a memory C 30C is connected to the CPU-C 20C, and a memory D 30D is connected to the CPU-D 20D. Each of the memories 30A to 30D stores data and processing result and so on to be used in processing in the CPUs 20A to 20D. In the memories 30A to 30D, storage areas different from one another are mapped.

Each of the CPUs 20A to 20D manages the memory, among the memories 30A to 30D, directly connected to the own CPU. Further, each of the CPUs 20A to 20D is accessible also to the memories managed by the other CPUs. In other words, the CPU 20A to 20D can refer not only to a memory space of the memory directly connected thereto but also to a memory space including the memories connected to the other CPUs. The access to the memories managed by the other CPUs is realized by inter-CPU communication (communication among the processors) via the bus 40. The inter-CPU communication is performed using a packet in a format whose example is illustrated in FIG. 2.

Further, in the multiprocessor system 10, it is possible to execute parallel processing in the plurality of independent CPUs while keeping consistency in the memory space of the whole system by organizing references from the plurality of CPUs 20A to 20D. For example, in the case where the CPU-B 20B refers to the memory C 30C, a request (data request) is sent from the CPU-B 20B to the CPU-C 20C. Then, the CPU-C 20C reads requested data from the memory C 30C and sends a packet containing the data to the CPU-B 20B after recording that the CPU-B 20B is using the data. Further, when a plurality of CPUs request to write data at the same time, conflict occurs, and therefore the CPU which has received the requests controls the order of writing the data and presents the memory space with consistency to the CPUs.

FIG. 2 is a chart illustrating an example of a packet transmitted/received in the communication among the CPUs 20A to 20D. The packet has a header part and a data part. The header part includes a source ID part HD1, a destination ID part HD2, a command part HD3, and a packet ID part HD4.

In the source ID part HD1, a source ID (source ID) being identification information for uniquely identifying a CPU that has sent a packet is recorded. In the destination ID part HD2, a destination ID (destination ID) being identification information for uniquely identifying a CPU that is the destination of the packet is recorded. The source ID and the destination ID are, for example, CPU numbers. In the command part HD3, information (command) instructing what operation is to be performed by the packet is stored. In the packet ID part HD4, identification information (for example, ID number) assigned for identifying each packet is stored.

In the data part, data accompanying a command is stored. A data length has a length according to the command. Therefore, the length of a packet is different depending on the command of the packet. In FIG. 2, a packet with a data length of 5 having first data DT1, second data DT2, third data DT3, fourth data DT4, and fifth data DT5, namely, with a packet length of 6 is illustrated as an example.

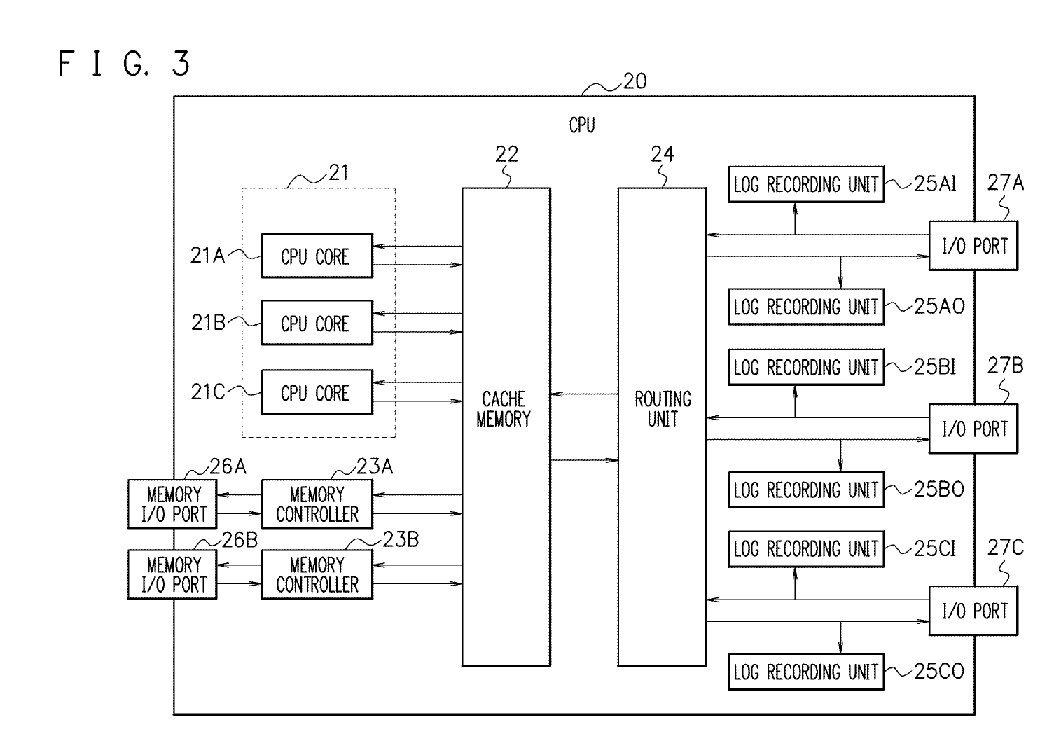

FIG. 3 is a block diagram illustrating a configuration example of the CPU in this embodiment. Each of the CPUs 20A to 20D illustrated in FIG. 1 has the configuration illustrated in FIG. 3. The CPU 20 has a processing unit 21, a cache memory 22, memory controllers 23A, 23B, a routing unit 24, and log recording units 25AI, 25AO, 25BI, 25BO, 25CI, 25CO. The CPU 20 further has a plurality of memory I/O (input/output) ports 26A, 26B, and a plurality of I/O (input/output) ports 27A, 27B, 27C. Note that the configuration illustrated in FIG. 3 is merely one example, and the numbers of CPU cores, memory controllers, memory I/O ports, I/O ports and so on included in the CPU 20 are not limited to those illustrated in FIG. 3 but arbitrary.

The processing unit 21 is an arithmetic processing unit that executes arithmetic processing according to a program or the like, and has, for example, a plurality of CPU cores 21A, 21B, 21C. The cache memory 22 is a cache memory to which part of data in a memory or the like outside the CPU 20 is copied. The CPU cores 21A, 21B, 21C are independently connected to the cache memory 22. Each of the CPU cores 21A, 21B, 21C executes arithmetic processing and requests data required for the processing to the cache memory 22.

The memory controllers 23A, 23B are connected to the cache memory 22 and the memory I/O ports 26A, 26B. The memory controller 23A, 23B receives a request for access to a memory connected to the memory I/O port 26A, 26B corresponding thereto and controls read and write of data from/to the memory in response to the request.

The routing unit 24 is connected to the cache memory 22 and the I/O ports 27A, 27B, 27C. The routing unit 24 performs communication control relating to a request and a packet containing data. Namely, the routing unit 24 receives a request or data inputted thereto and transmits the received request or data to one of the cache memory 22 and the I/O ports 27A, 27B, 27C on the basis of the destination information or the like. The I/O ports 27A, 27B, 27C are interfaces for connecting the own CPU 20 with the other CPUs to be communicable. To the I/O ports 27A, 27B, 27C, not-illustrated other CPUs having the same function as that of the CPU 20 are connected.

The log recording units 25AI, 25AO, 25BI, 25BO, 25CI, 25CO are connected to buses between the routing unit 24 and the I/O ports 27A, 27B, 27C. For each I/O port, the log recording unit is provided for each of the bus on an input side on which a request or data is transmitted from the I/O port to the routing unit and the bus on an output side on which a request or data is transmitted from the routing unit to the I/O port.

Each of the log recording units 25AI, 25AO, 25BI, 25BO, 25CI, 25CO monitors the bus connected thereto and records information about a packet transmitted/received on the bus. In other words, each of the log recording units 25AI, 25AO, 25BI, 25BO, 25CI, 25CO records log information (communication log) relating to the inter-CPU communication between the own CPU 20 and the other CPUs connected thereto via the I/O ports.

Next, the operation of the CPU 20 will be described.

In the CPU 20, the operation when the processing unit 21 requests data required for executing processing to the cache memory 22 is performed as follows. If the data requested by the processing unit 21 exists in the cache memory (cache hit), the data is read from the cache memory 22 and supplied to the processing unit 21.

On the other hand, if the data requested by the processing unit 21 does not exist in the cache memory 22 (cache miss), the cache memory 22 determines whether the requested data exists in the memories connected to the memory I/O ports 26A, 26B. As a result, when it is determined that the requested data exists in the memory connected to the memory I/O port 26A, 26B, the memory controller 23A, 23B accesses the memory in response to a request from the cache memory 22. Then, the data read from the memory by the memory controller 23A, 23B is supplied to the processing unit 21 via the cache memory 22.

When determining that the requested data does not exist in the memories connected to the memory I/O ports 26A, 26B, the cache memory 22 sends a packet for requesting the data requested by the processing unit 21 to the routing unit 24. This packet is a packet relating to a data request for acquiring the data requested by the processing unit 21 by reading the data from the memory connected to the other CPU.

Upon receiving the packet relating to the data request from the cache memory 22, the routing unit 24 transmits the packet via one of the I/O ports 27A to 27C on the basis of the destination information or the like contained in the packet. Upon receiving a packet containing the requested data via one of the I/O ports 27A to 27C as a response to the packet relating to the transmitted data request, the routing unit 24 sends the packet to the cache memory 22. Then, the data contained in the received packet is supplied to the processing unit 21 via the cache memory 22.

For instance, it is assumed that the packet relating to the data request is transmitted via the I/O port 27A and the packet containing data as a response is received via the I/O port 27A. In this case, at the time when the packet relating to the data request is transmitted by the routing unit 24 via the I/O port 27A, the log recording unit 25AO records information about the packet relating to the data request. Further, at the time when the packet containing data is received by the routing unit 24 via the I/O port 27A, the log recording unit 25AI records information about the packet containing data.

Further, in the CPU 20, the operation when a packet relating to a data request from another CPU requesting data stored in the memory connected to the memory I/O port 26A, 26B is received is performed as follows. Upon receiving the packet relating to the data request from the another CPU via the I/O port 27A to 27C, the routing unit 24 sends the packet to the cache memory 22. Then, in response to a request from the cache memory 22 based on the packet relating to the data request, the memory controller 23A, 23B accesses the memory, and data read from the memory is supplied to the cache memory 22. The cache memory 22 sends a packet containing the data read from the memory to the routing unit 24 regarding the source of the packet relating to the data request as a destination. Upon receiving the packet containing the data from the cache memory 22, the routing unit 24 transmits the packet via the I/O port 27A to 27C on the basis of the destination information or the like contained in the packet.

For instance, in the above-described operation, it is assumed that the packet relating to the data request is received via the I/O port 27B and the packet containing the data as a response thereto is transmitted via the I/O port 27B. In this case, at the time when the packet relating to the data request is received by the routing unit 24 via the I/O port 27B, the log recording unit 25BI records information about the packet relating to the data request. Further, at the time when the packet containing the data is transmitted by the routing unit 24 via the I/O port 27B, the log recording unit 25BO records information about the packet containing the data.

Further, in the CPU 20, the operation when a packet relating to a data request, a packet containing data as a response thereto or the like is relayed, namely, a packet from another CPU is received and transmitted to another CPU is performed as follows. Upon receiving a packet from another CPU via the I/O port 27A to 27C, the routing unit 24 confirms destination information contained in the packet. Then, the routing unit 24 transmits the received packet via the I/O port 27A to 27C according to the destination information. For instance, it is assumed that the packet is received via the I/O port 27A and transmitted via the I/O port 27B. In this case, the log recording unit 25AI records information about the received packet at the time when the packet is received, and the log recording unit 25BO records information about the transmitted packet at the time when the packet is transmitted.

Here, when a packet is transferred via a plurality of CPUs, the same information is conventionally recorded as log information in logs of the CPUs on a transfer route. In contrast, in this embodiment, logs existing in the respective CPUs are recognized to be independent but logs existing in the plurality of CPUs on the transfer route of the packet are recognized as one united log, and the log recording unit records the log information so that an overlap portion becomes smaller. In the multiprocessor system in this embodiment, the CPUs on the transfer route do not have the complete information as logs, but part of the CPUs on the transfer route record the complete information as logs. Further, the other CPUs abbreviate the information and record the abbreviated information to thereby reduce their storage areas to be used for recording log information. Note that the complete information means information containing the header part and the data part of the transmitted/received packet as they are. Thus, the log information is recorded to satisfy both points (1) that a packet is transferred accurately and reliably in a correct sequence, which is recorded, and (2) that the data part of the packet is correctly transferred, which is recorded. Further, a great effect can be achieved also in a point (3) that logs in a longer time can be recorded in a smaller storage area.

However, if the complete information is concentrated in logs of a specific CPU, only the logs of the specific CPU are utilized. Therefore, it is desirable to appropriately distribute recording of the complete information to a plurality of CPUs. In the transfer of the packet via a plurality of CPUs, the complete information about the transferred packet only needs to be recorded once or more. Hence, in this embodiment, the log recording unit determines whether or not to record the complete information about the packet by using information relating to the transfer route. For example, the log recording unit determines whether or not to record the complete information on the basis of source information or destination information contained in the packet. Then, when recording the complete information, the log recording unit records the header part and the data part of the packet as they are, whereas when abbreviating the information and recording the abbreviated information, the log recording unit records the header part of the packet as it is and reduces the data amount of the data part and then records the resultant data part.

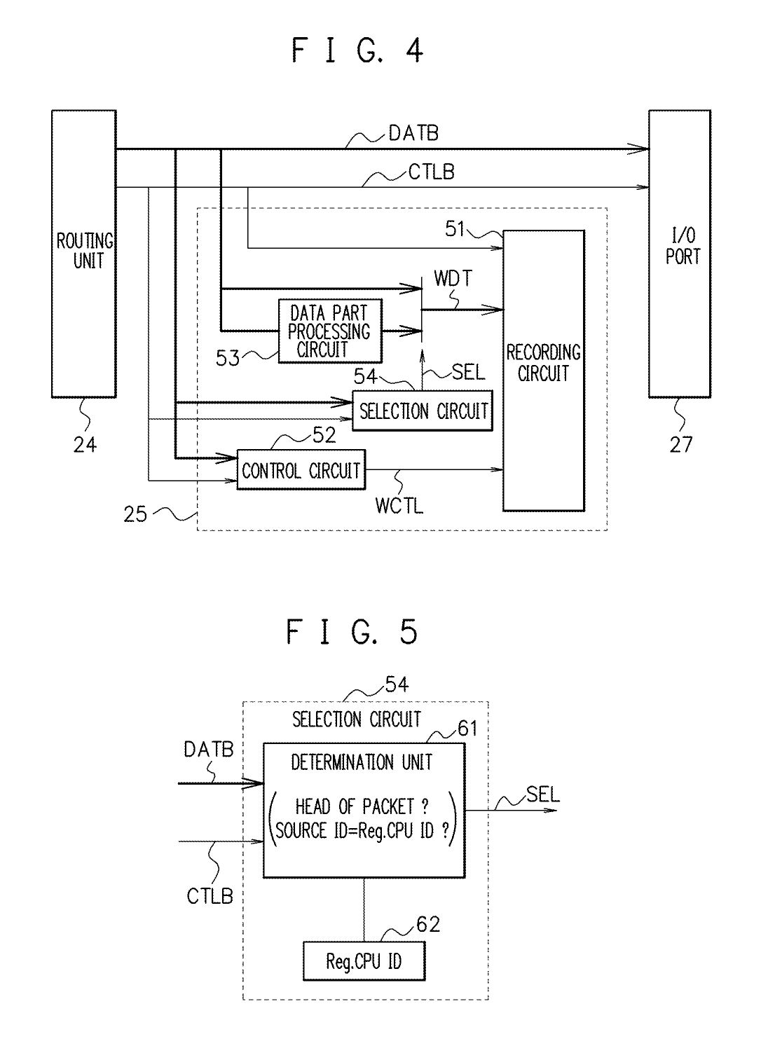

FIG. 4 is a block diagram illustrating a configuration example of the log recording unit in the first embodiment. The log recording unit in the first embodiment records the complete information when the source ID recorded in the source ID part HD1 of the header part of the packet matches the ID of the own CPU, and abbreviates the information and records the abbreviated information when they do not match each other. FIG. 4 illustrates the log recording unit 25 connected to the bus on the output side where a request or data is transmitted from the routing unit 24 to the I/O port 27. Note that the log recording unit connected to the bus on the input side where a request or data is transmitted from the I/O port to the routing unit, is reverse only in transmission direction of signals on the bus between the I/O port and the routing unit and is the same in the other configuration and so on.

The log recording unit 25 has a recording circuit 51, a control circuit 52, a data part processing circuit 53, and a selection circuit 54. The recording circuit 51 is a circuit that records and holds information as logs. The recording circuit 51 is, for example, a RAM (Random Access Memory) or a register file. The control circuit 52 controls the recording circuit 51 and instructs the recording circuit 51 about the recording timing when writing information. The control circuit 52 generates a write control signal WCTL and outputs it to the recording circuit 51, on the basis of a signal transmitted on a data bus DATB and a control bus CTLB.

Here, the data bus DATB is a bus on which real data (containing the header part and the data part) constituting a transmitted packet is transmitted. Further, the control bus CTLB is a bus on which in synchronization with the data transmitted on the data bus DATB, control information other than the data is transmitted. The control information transmitted on the control bus CTLB contains, for example, information indicating a head portion, a data portion, a last portion and so on of the packet. Further, the control information may contain accompanying information indicating that the packet is broken.

The data part processing circuit 53 takes in the data transmitted on the data bus DATB and outputs processed data on the basis of the data. The data part processing circuit 53 generates the processed data by processing the data taken in so that the data of the packet having changed during communication can be determined and the data size is reduced. For example, if data such as CRC (Cyclic Redundancy Check: Cyclic Redundancy Code) or the like is stored in the data part (for example, in the last portion of the data part) in a specific cycle, for instance, the data part processing circuit 53 may generate the processed data by extracting the data part in the specific cycle from the packet. Further, the data part processing circuit 53 may perform an exclusive logical sum operation on the data part in each cycle for each corresponding bit and use the operation result as the processed data. Further, for instance, the data part processing circuit 53 may generate a CRC on the basis of the data part in each cycle and use it as the processed data.

The selection circuit 54 selects which of the data transmitted on the data bus DATB and the processed data outputted from the data part processing circuit 53 is to be supplied to the recording circuit 51 as write data WDT. In other words, the selection circuit 54 selects either the data transmitted on the data bus DATB or the processed data outputted from the data part processing circuit 53, as log information to be written into the recording circuit 51. The selection circuit 54 outputs a selection signal SEL relating to data selection on the basis of the signals transmitted on the data bus DATB and the control bus CTLB.

FIG. 5 is a block diagram illustrating a configuration example of the selection circuit 54 in the first embodiment. A determination unit 61 determines which of the data transmitted on the data bus DATB and the processed data outputted from the data part processing circuit 53 is to be outputted as the write data WDT on the basis of the signals transmitted on the buses DATB, CTLB. If the data transmitted on the data bus DATB is the head (header part) of the packet, the determination unit 61 outputs the selection signal SEL so that the data transmitted on the data bus DATB is outputted as the write data WDT.

Further, the determination unit 61 compares the source ID recorded in the source ID part HD1 of the header part of the packet with the ID of the own CPU stored in the register 62. As a result of the comparison, if the source ID and the ID of the own CPU match each other, the determination unit 61 outputs the selection signal SEL so as to output all the data part in the packet transmitted on the data bus DATB as the write data WDT. On the other hand, if the source ID and the ID of the own CPU do not match each other, the determination unit 61 outputs the selection signal SEL so as to output the processed data outputted from the data part processing circuit 53 as the write data WDT.

As described above, the log recording unit 25 in the first embodiment monitors the data bus DATB and the control bus CTLB by the control circuit 52, and notifies the recording circuit 51 of an information write instruction when an effective packet is transmitted. The recording circuit 51 holds the write data WDT according to the recording timing instructed by the write control signal WCTL outputted from the control circuit 52. As the write data WDT, the data transmitted on the data bus DATB or the processed data outputted from the data part processing circuit 53 is outputted according to the instruction by the selection signal SEL outputted from the selection circuit 54.

In the first embodiment, if the source ID of the packet and the ID of the own CPU match each other, the header part and all the data part of the packet transmitted on the data bus DATB are recorded as the log information in the log recording unit 25. On the other hand, if the source ID of the packet and the ID of the own CPU do not match each other, the header part of the packet transmitted on the data bus DATB and the processed data outputted from the data part processing circuit 53 are recorded as the log information in the log recording unit 25. In short, the complete information about the packet is recorded in the log recording unit 25 on the output side of the CPU being the source, and the abbreviated information about the packet is recorded in the log recording unit 25 of each of the CPUs through which the packet passes thereafter.

Thus, if an error occurs in the packet during communication due to a failure, the processed data changes en route. Therefore, by confirming the logs recorded in each CPU, it is found that the failure has occurred at a point where the processed data has changed. Further, by referring to the complete information about the packet recorded in the logs of the CPU being the source, what packet has been transmitted is found. Furthermore, by referring to the logs of each CPU, communication logs of the inter-CPU communication from the time when abnormality is detected to the time when the log is left can be reconstructed.

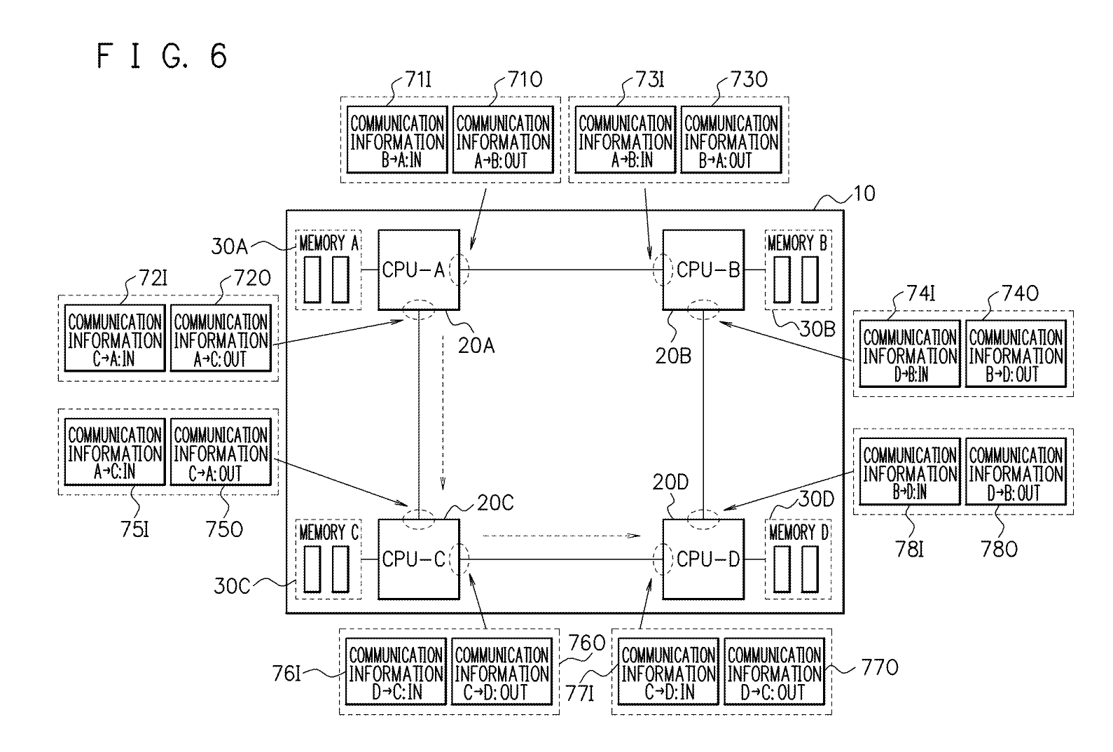

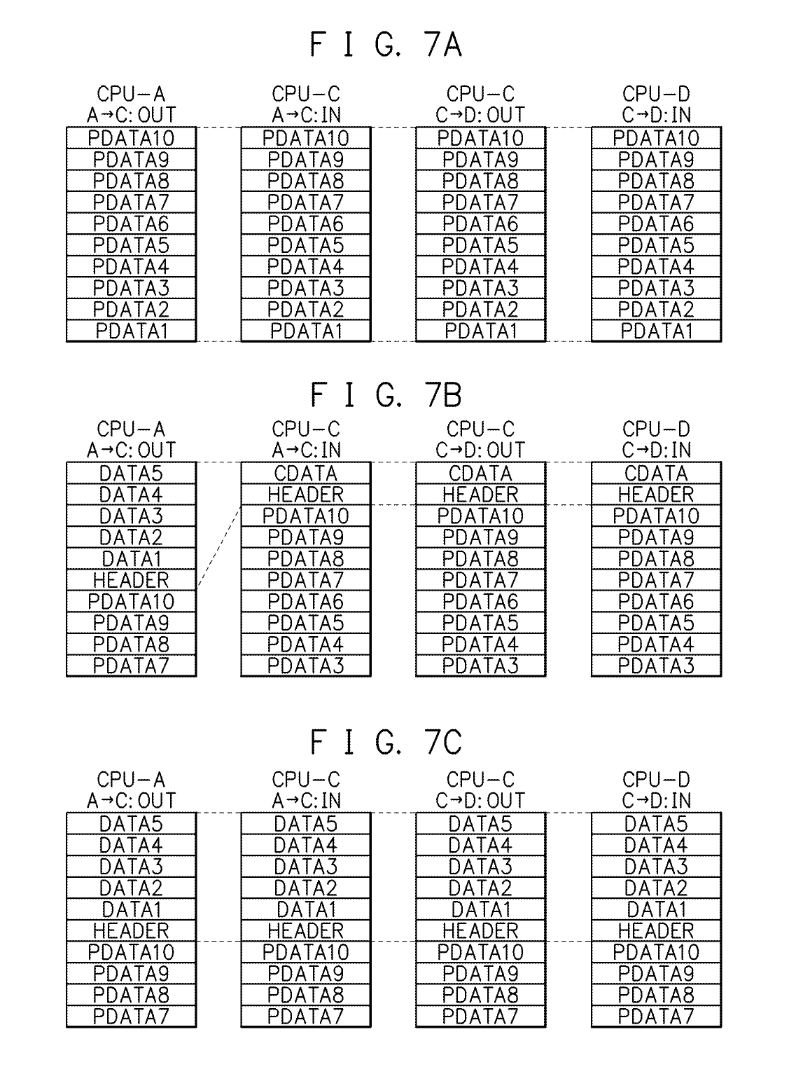

A concrete recording example of log information in this embodiment will be described referring to FIG. 6 and FIG. 7A to FIG. 7C. As illustrated in FIG. 6, in the multiprocessor system illustrated in FIG. 1, information (output side) 710 relating to packet communication from the CPU-A 20A to the CPU-B 20B and information (input side) 711 relating to packet communication from the CPU-B 20B to the CPU-A 20A are recorded as logs in the CPU-A 20A. Further, in the CPU-A 20A, information (output side) 720 relating to packet communication from the CPU-A 20A to the CPU-C 20C and information (input side) 721 relating to packet communication from the CPU-C 20C to the CPU-A 20A are recorded as logs. In the CPU-B 20B, information (output side) 730 relating to packet communication from the CPU-B 20B to the CPU-A 20A and information (input side) 731 relating to packet communication from the CPU-A 20A to the CPU-B 20B are recorded as logs. Further, in the CPU-B 20B, information (output side) 740 relating to packet communication from the CPU-B 20B to the CPU-D 20D and information (input side) 741 relating to packet communication from the CPU-D 20D to the CPU-B 20B are recorded as logs.

Similarly, in the CPU-C 20C, information (output side) 750 relating to packet communication from the CPU-C 20C to the CPU-A 20A and information (input side) 751 relating to packet communication from the CPU-A 20A to the CPU-C 20C are recorded as logs. Further, in the CPU-C 20C, information (output side) 760 relating to packet communication from the CPU-C 20C to the CPU-D 20D and information (input side) 761 relating to packet communication from the CPU-D 20D to the CPU-C 20C are recorded as logs. In the CPU-D 20D, information (output side) 770 relating to packet communication from the CPU-D 20D to the CPU-C 20C and information (input side) 771 relating to packet communication from the CPU-C 20C to the CPU-D 20D are recorded as logs. Further, in the CPU-D 20D, information (output side) 780 relating to packet communication from the CPU-D 20D to the CPU-B 20B and information (input side) 781 relating to packet communication from the CPU-B 20B to the CPU-D 20D are recorded as logs.

Here, an example of the recording state of logs when a packet of a 6-cycle type having the header part of 1 cycle and the data part having 5 cycles as illustrated in FIG. 2 is transferred from the CPU-A 20A to the CPU-D 20D via the CPU-C 20C is illustrated. As illustrated in FIG. 7A to FIG. 7C, when a packet is transferred in the order of the CPU-A→the CPU-C→the CPU-D, the information about the packet is recorded as logs in each of the CPU-A 20A, the CPU-C 20C, and the CPU-D 20D. In the CPU-A 20A, logs are recorded in the log recording unit (CPU-A A→C:OUT) in a direction from the CPU-A 20A toward the CPU-C 20C (output side). In the CPU-C 20C, logs are recorded in the log recording unit (CPU-C A→C: IN) in a direction from the CPU-A 20A toward the CPU-C 20C (input side) and in the log recording unit (CPU-C C→D:OUT) in a direction from the CPU-C 20C toward the CPU-D 20D (output side). Further, in the CPU-D 20D, logs are recorded in the log recording unit (CPU-D C→D:IN) in a direction from the CPU-C 20C toward the CPU-D 20D (input side).

FIG. 7A schematically illustrates an example of the recording state in each log recording unit before packet transfer, and information PDATA1 to PDATA10 recorded as logs in the past are recorded. Note that in each log recording unit, the information recorded as a log is pushed in sequence from the top in an input order, and information exceeding the storage area is erased (flushed). In other words, the information at a lower side means older information in terms of time in the examples illustrated in FIG. 7A to FIG. 7C.

FIG. 7B schematically illustrates an example of the recording state of logs in each log recording unit after packet transfer in the first embodiment. In the first embodiment, the complete information about the packet is recorded when the source ID of the packet and the ID of the own CPU match each other, and otherwise, the information about the packet is abbreviated and then recorded. Accordingly, as illustrated in FIG. 7B, the header part (HEADER) and all the data part (DATA1 to DATA5) of the packet are recorded in the log recording unit (CPU-A A→C:OUT) on the output side of the CPU-A 20A being the source. On the other hand, the header part (HEADER) of the packet and the processed data CDATA based on the data part (DATA1 to DATA5) are recorded in the log recording units of the other CPU-C 20C and CPU-D 20D.

FIG. 7C schematically illustrates a comparative reference example of the recording state of logs after packet transfer, illustrating an example that each of the log recording units records the header part (HEADER) and all the data part (DATA1 to DATA5) of the packet as logs.

As is clear from comparison between FIG. 7B and FIG. 7C, in this embodiment, if the source ID of the packet and the ID of the own CPU do not match each other, the header part of the packet and the processed data with reduced data amount are recorded as logs, thereby making it possible to reduce the storage capacity (storage area) for recording logs. Further, since the amount of data to be recorded as logs is reduced, old information to be flushed accompanying the recording of new information is reduced, so that logs in a longer period can be recorded in the case of the same storage capacity (storage area). Further, the header part and all the data part of the packet are recorded in the CPU having the ID matching the source ID of the packet, thereby making it possible to analyze also the data part by referring to them.

According to the first embodiment, if the source ID of the transmitted/received packet and the ID of the own CPU match each other, the header part and all the data part of the packet being the complete information about the packet are recorded as logs. On the other hand, if the source ID of the transmitted/received packet and the ID of the own CPU do not match each other, the information about the packet is abbreviated and the header part of the packet and the processed data with reduced data amount are recorded as logs. This makes it possible to reduce the amount of data to be recorded as logs so that logs in a longer period can be recorded. Accordingly, the state transition of hardware can be traced for a long period to facilitate, for example, analysis of a failure cause when communication abnormality occurs. Further, since all the data part of the packet is recorded in the CPU being the source, failure analysis relating to the data part can be performed. As described above, it becomes possible to provide logs in a longer period and complete information about a packet including all the data part and facilitate reliable detection of a failure and specification of a failure location.

### Second Embodiment

Next, a second embodiment of the present invention will be described.

In the above-described first embodiment, if the source ID of the transmitted/received packet and the ID of the own CPU match each other, the log recording unit records the complete information about the packet, and if they do not match each other, the information is abbreviated and then recorded. In the second embodiment described below, if the destination ID of the transmitted/received packet and the ID of the own CPU match each other, the complete information about the packet is recorded in the log recording unit, and if they do not match each other, the information is abbreviated and then recorded. Note that in the second embodiment, the configuration of the selection circuit 54 included in the log recording unit 25 is different from that in the first embodiment. The other configuration in the second embodiment is the same as that in the first embodiment, and the description thereof will be omitted.

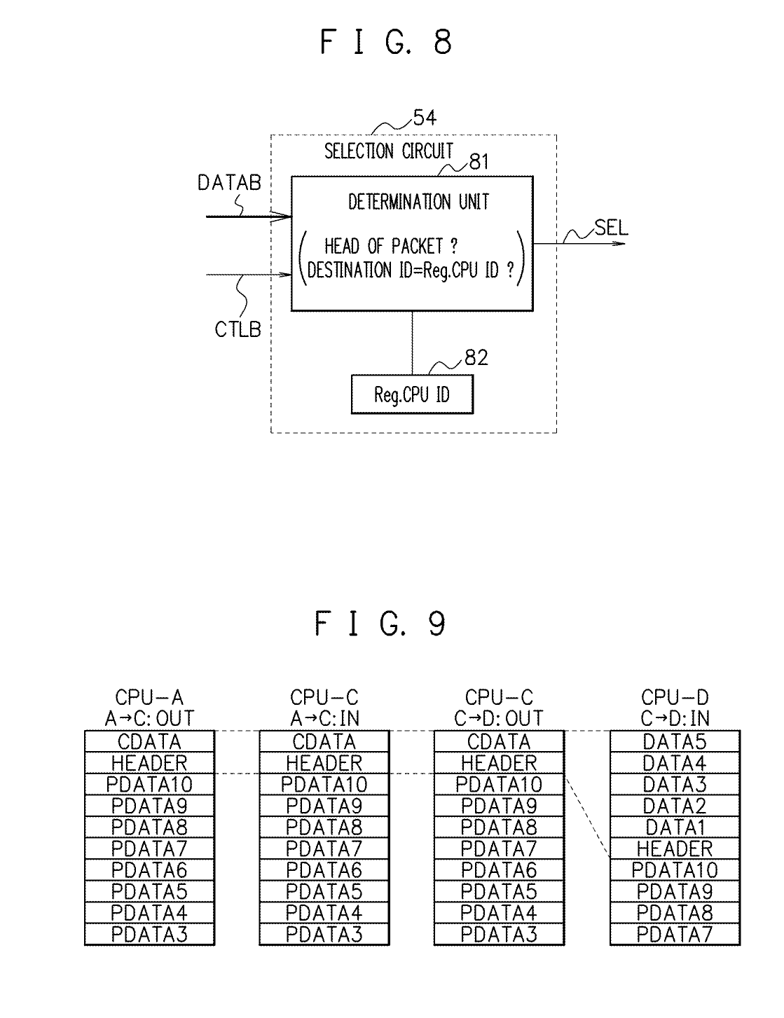

FIG. 8 is a block diagram illustrating a configuration example of the selection circuit 54 in the second embodiment. A determination unit 81 determines which of the data transmitted on the data bus DATB and the processed data outputted from the data part processing circuit 53 is to be outputted as the write data WDT on the basis of the signals transmitted on the buses DATB, CTLB. If the data transmitted on the data bus DATB is the head (header part) of the packet, the determination unit 81 outputs the selection signal SEL so that the data transmitted on the data bus DATB is outputted as the write data WDT.

Further, the determination unit 81 compares the destination ID recorded in the destination ID part HD2 of the header part of the packet with the ID of the own CPU stored in a register 82. As a result of the comparison, if the destination ID and the ID of the own CPU match each other, the determination unit 81 outputs the selection signal SEL so as to output all the data part in the packet transmitted on the data bus DATB as the write data WDT. On the other hand, if the destination ID and the ID of the own CPU do not match each other, the determination unit 81 outputs the selection signal SEL so as to output the processed data outputted from the data part processing circuit 53 as the write data WDT.

Accordingly, in the second embodiment, if the destination ID of the packet and the ID of the own CPU match each other, the header part and all the data part of the packet transmitted on the data bus DATB are recorded as the log information in the log recording unit 25. On the other hand, if the destination ID of the packet and the ID of the own CPU do not match each other, the header part of the packet transmitted on the data bus DATB and the processed data outputted from the data part processing circuit 53 are recorded as the log information in the log recording unit 25. In short, the complete information about the packet is recorded in the log recording unit 25 on the input side of the CPU being the destination, and the abbreviated information about the packet is recorded in the log recording unit 25 of each of the other CPUs. Thus, if an error occurs in the packet during communication due to a failure, the processed data changes en route. Therefore, by confirming the logs recorded in each CPU, it is found that the failure has occurred at a point where the processed data has changed. Further, by referring to the complete information about the packet recorded in the logs of the CPU being the destination, what packet has been transmitted is found. Furthermore, by referring to the logs of each CPU, communication logs of the inter-CPU communication from the time when abnormality is detected to the time when the log is left can be reconstructed.

FIG. 9 schematically illustrates an example of the recording state of logs in each log recording unit after packet transfer in the second embodiment when a packet is transferred in the order of the CPU-A→the CPU-C→the CPU-D. As illustrated in FIG. 9, in the second embodiment, the header part (HEADER) and all the data part (DATA1 to DATA5) of the packet are recorded in the log recording unit (CPU-D C→D:IN)) on the input side of the CPU-D 20D being the destination. On the other hand, the header part (HEADER) of the packet and the processed data CDATA based on the data part (DATA1 to DATA5) are recorded in the log recording units of the other CPU-A 20A and CPU-C 20C.

As described above, according to the second embodiment, if the destination ID of the transmitted/received packet and the ID of the own CPU match each other, the header part and all the data part of the packet being the complete information about the packet are recorded as logs. On the other hand, if the destination ID of the transmitted/received packet and the ID of the own CPU do not match each other, the information about the packet is abbreviated and the header part of the packet and the processed data with reduced data amount are recorded as logs. Thus, the same effect as that of the first embodiment can be achieved. More specifically, it becomes possible to reduce the amount of data to be recorded as logs so that logs in a longer period can be recorded and the state transition of hardware can be traced for a long period, thereby facilitating, for example, analysis of a failure cause when communication abnormality occurs. Further, since all the data part of the packet is recorded in the CPU being the destination, failure analysis relating to the data part can be performed. As described above, it becomes possible to provide logs in a longer period and complete information about a packet including all the data part and facilitate reliable detection of a failure and specification of a failure location.

Note that the above-described embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

In communication among processors in a multiprocessor system, it becomes possible to select and record data of a packet or processed data as log information according to communication information contained in the packet. The amount of data recorded as the log information is reduced to enable log recording in a limited storage area for a long period and reliable detection of communication abnormality.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a plurality of processors communicating data via a bus,
wherein any one of the plurality of processors including
a receiving unit that receives data transmitted by another processor;
a generating unit that generates, on the basis of received data received by the receiving unit, processed data smaller in size than the data received by the receiving unit;
a selection unit that selects either the received data or the processed data on the basis of control information contained in the received data; and
a control unit that writes selected data selected by the selection unit into a storage unit.

2. The information processing apparatus according to claim 1,
wherein the selection unit selects the received data if identification information specifying the another processor matches identification information identifying the processor having the selection unit, and selects the processed data if the identification information specifying the another processor does not match.

3. The information processing apparatus according to claim 1,
wherein the selection unit selects the received data if identification information specifying a processor that has received the data matches identification information identifying the processor having the selection unit, and selects the processed data if the identification information specifying the processor that has received the data does not match.

4. The information processing apparatus according to claim 1,
wherein the processed data is a result of performing an exclusive logical sum operation on a data body contained in the received data.

5. The information processing apparatus according to claim 1,
wherein the processed data is a cyclic redundancy code generated for a data body contained in the received data.

6. A processor connected to another processor communicating data via a bus, the processor comprising:
a receiving unit that receives data transmitted by the another processor;
a generating unit that generates, on the basis of received data received by the receiving unit, processed data smaller in size than the data received by the receiving unit;
a selection unit that selects either the received data or the processed data on the basis of control information contained in the received data; and
a control unit that writes selected data selected by the selection unit into a storage unit.

7. The processor according to claim 6,
wherein the selection unit selects the received data if identification information specifying the another processor matches identification information identifying the processor having the selection unit, and selects the processed data if the identification information specifying the another processor does not match.

8. The processor according to claim 6,
wherein the selection unit selects the received data if identification information specifying a processor that has received the data matches identification information identifying the processor having the selection unit, and selects the processed data if the identification information specifying the processor that has received the data does not match.

9. The processor according to claim 6,
wherein the processed data is a result of performing an exclusive logical sum operation on a data body contained in the received data.

10. The processor according to claim 6,
wherein the processed data is a cyclic redundancy code generated for a data body contained in the received data.

11. A control method of an information processing apparatus including a plurality of processors communicating data via a bus, the control method comprising:
receiving, by a receiving unit of the processor, data transmitted by another processor;
generating, by a generating unit of the processor, on the basis of received data received by the receiving unit, processed data smaller in size than the data received by the receiving unit;
selecting, by a selection unit of the processor, either the received data or the processed data on the basis of control information contained in the received data; and
writing, by a control unit of the processor, selected data selected by the selection unit into a storage unit.
